(19) United States
(12) Patent Application Publication
(10) Pub. No.: US 2024/0308374 A1
(43) Pub. Date: Sep. 19, 2024

(54) VEHICLE MANAGEMENT DEVICE

(71) Applicant: TOYOTA JIDOSHA KABUSHIKI KAISHA, Toyota-shi (JP)

(72) Inventor: Masaki NUMAKURA, Miyoshi-shi (JP)

(73) Assignee: TOYOTA JIDOSHA KABUSHIKI KAISHA, Toyota-shi (JP)

(21) Appl. No.: 18/539,554

(22) Filed: Dec. 14, 2023

(30) Foreign Application Priority Data
Mar. 13, 2023 (JP) 2023-038564

(51) Int. Cl. B60L 53/60

(52) U.S. Cl. CPC B60L 53/60; B60L 2240/80

(57) ABSTRACT

In a vehicle management device that is used in an electrified vehicle equipped with a power storage device, and sets, when the electrified vehicle is able to transmit and receive power to and from a predetermined facility, a charging start time for external charging for charging the power storage device using power from the predetermined facility, based on a next scheduled travel start time or a set time, when the electrified vehicle is able to transmit and receive the power to and from the predetermined facility, the charging start time is set based on scheduled charging power in the external charging, the scheduled charging power being determined within a range of allowable power of the predetermined facility.

### CROSS-REFERENCE TO RELATED APPLICATION

This application claims priority to Japanese Patent Application No. 2023-038564 filed on Mar. 13, 2023 incorporated herein by reference in its entirety.

### BACKGROUND

### 1. Technical Field

The present disclosure relates to a vehicle management device.

### 2. Description of Related Art

Conventionally, as this type of technique, a power management system has been proposed in which a change in the power supply and demand gap, which is a difference between the amount of power generated by power generating equipment and the amount of power consumed by power consuming equipment, is predicted for each microgrid, vehicle information including the remaining charge level of a power storage device for an electrified vehicle located within an area corresponding to each microgrid is acquired, and based on these, information on charging and discharging of the power storage device is distributed to the electrified vehicle (for example, see Japanese Unexamined Patent Application Publication No. 2020-114090 (JP 2020-114090 A)).

### SUMMARY

In an electrified vehicle equipped with a power storage device, when power can be transmitted to and received from a predetermined facility such as a home or a workplace, based on a next scheduled travel start time and the like, processing is performed in which a charging start time for external charging for charging the power storage device using power from the predetermined facility is set. When the charging start time is set to a relatively early time by performing this external charging using relatively small constant power, a period during which power can be supplied from the electrified vehicle to the predetermined facility becomes relatively short.

A main object of a vehicle management device of the present disclosure is to suppress shortening of the period during which the power can be supplied from the electrified vehicle to the predetermined facility.

The vehicle management device of the present disclosure employs the following measures to achieve the main object.

The gist of a vehicle management device of the present disclosure is a vehicle management device that is used in an electrified vehicle equipped with a power storage device, and sets, when the electrified vehicle is able to transmit and receive power to and from a predetermined facility, a charging start time for external charging for charging the power storage device using power from the predetermined facility, based on a next scheduled travel start time or a set time, in which

when the electrified vehicle is able to transmit and receive the power to and from the predetermined facility, the charging start time is set based on scheduled charging power in the external charging, the scheduled charging power being determined within a range of allowable power of the predetermined facility.

In the vehicle management device of the present disclosure, when the electrified vehicle can transmit ad receive the power to and from the predetermined facility, the charging start time is set based on the scheduled charging power in the external charging, the scheduled charging power being determined within the range of the allowable power of the predetermined facility. Therefore, by appropriately setting the charging start time based on the scheduled charging power, it is possible to suppress shortening of the period during which the power can be supplied from the electrified vehicle to the predetermined facility. Here, examples of the predetermined facility include a home, a workplace, and the like.

In the vehicle management device of the present disclosure, the charging start time may be set to be late as the scheduled charging power is large. In this way, the charging start time can be set more appropriately. Further, when the scheduled charging power is relatively large, it is possible to further suppress shortening of the period during which the power can be supplied from the electrified vehicle to the predetermined facility.

In the vehicle management device of the present disclosure, the scheduled charging power may be set based on surplus power obtained as a difference between the allowable power and predicted power consumption of the predetermined facility. In this case, the predicted power consumption may be estimated based on a history for a predetermined period. Further, the scheduled charging power may be set to increase as the surplus power is large. Thereby, the scheduled charging power can be set more appropriately.

In the vehicle management device of the present disclosure, the scheduled charging power may be set within a range of the allowable power based on the predicted power consumption of the predetermined facility. In this case, the scheduled charging power may be set to decrease as the predicted power consumption is large. Thereby, the scheduled charging power can be set more appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an electric power system 10 including an electrified vehicle 20 equipped with a vehicle management device according to the present embodiment;

FIG. 2 is a flowchart showing an example of a charging start time setting routine executed by the electronic control unit 40 of the electrified vehicle 20; and

FIG. 3 is an explanatory diagram showing an example of the state of the power storage ratio SOC of the battery 26 of the electrified vehicle 20.

### DETAILED DESCRIPTION OF EMBODIMENTS

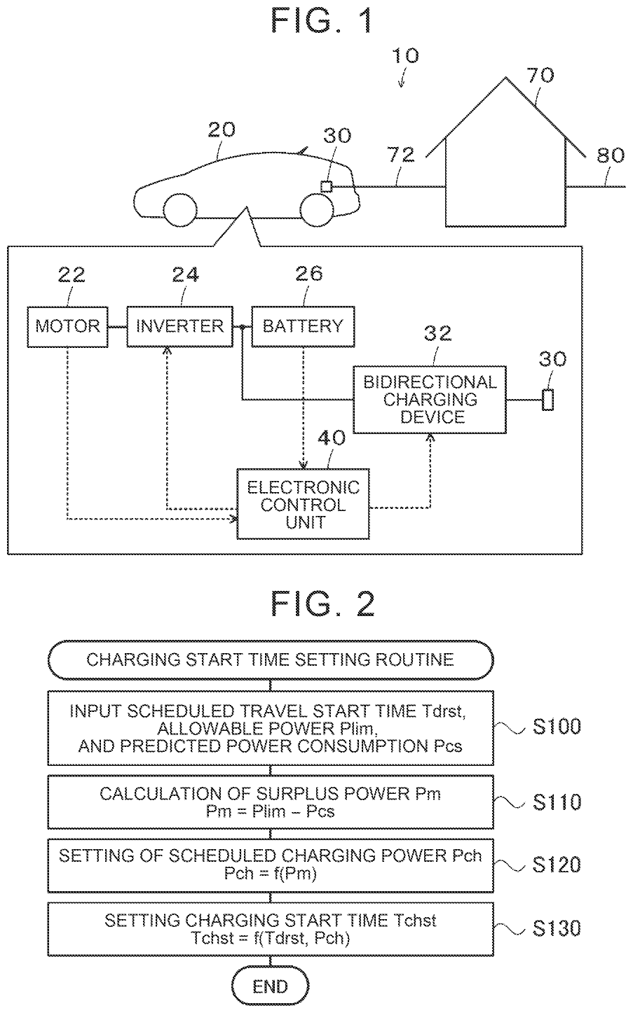

Embodiments of the present disclosure will be described with reference to the drawings. FIG. 1 is a schematic configuration diagram of an electric power system 10 including an electrified vehicle 20 equipped with a vehicle management device of this embodiment. As illustrated, the power system 10 includes an electrified vehicle 20, predetermined facility 70 such as a home or office, and a power system 80. The electrified vehicle 20 is configured as a battery electric vehicle and includes a motor 22, an inverter 24, a battery 26 as a power storage device, a connector 30, a bidirectional charging device 32, and an electronic control unit 40. The electronic control unit 40 corresponds to the vehicle management device of this embodiment.

The motor 22 is configured, for example, as a synchronous generator motor, and the rotor of the motor 22 is connected to a drive shaft connected to drive wheels. Inverter 24 is used to drive motor 23 and is connected to battery 26 via a power line. The battery 26 is configured as, for example, a lithium ion secondary battery or a nickel hydride secondary battery.

The connector 30 can be connected to a predetermined facility 70 via a relay cable 72. Here, the predetermined facility 70 is connected to the power system 80 and can receive power from the power system 80 or supply power to the power system 80.

When the connector 30 and the predetermined facility 70 are connected via the relay cable 72, the bidirectional charging device 32 can supply power from the predetermined facility 70 to the battery 26, and supply power from the battery 26 to the predetermined facility 70.

The electronic control unit 40 includes a microcomputer, and the microcomputer includes a CPU, ROM, RAM, flash memory, input/output ports, and communication ports. The electronic control unit 40 receives signals from various sensors through input ports. Examples of the signals inputted to the electronic control unit 40 include the rotational position Om of the rotor of the motor 22, the phase currents Iu, Iv, and Iw of each phase of the motor 22, the voltage Vb of the battery 26, and the current Ib of the battery 26. The electronic control unit 40 outputs various control signals through output ports. Examples of the signals output by the electronic control unit 40 include a control signal to the inverter 24 and a control signal to the bidirectional charging device 32. The electronic control unit 40 calculates the power storage ratio SOC of the battery 26 based on the integrated value of the current Ib of the battery 26. The electronic control unit 40 communicates with a predetermined facility 70 and an aggregator that manages the power system 80.

In the thus configured electrified vehicle 20 of this embodiment, the electrified vehicle 20 and the predetermined facility 70 are connected via the relay cable 72. In addition, when the next scheduled travel start time Tdrst is set, the charging start time Tchst for external charging to charge the battery 26 using the power from the predetermined facility 70 is set based on the next scheduled travel start time Tdrst. As the next scheduled running start time Tdrst, a time set by the user may be used, or a time set based on a history of past running start times may be used. Then, when the charging start time Tchst is reached, charging control is started to control the bidirectional charging device 32 so that external charging is performed. Thereafter, when the power storage ratio SOC of the battery 26 reaches the target ratio SOCtg, the charging control is ended. In this way, charging of the battery 26 is completed by the scheduled travel start time Tdrst.

Next, the operation of the power system 10 of this embodiment, particularly the operation when setting the charging start time Tchst for external charging when a predetermined condition is satisfied, will be described. The predetermined conditions are that the electrified vehicle 20 and the predetermined facility 70 are connected via the relay cable 72, and that power is not supplied from the electrified vehicle 20 to the outside of the vehicle (the predetermined facility 70 or the power system 80 via the predetermined facility 70). The conditions are that external power supply is permitted and that the next scheduled running start time Tdrst is set. When external power supply is permitted includes when the electrified vehicle 20 is participating in a virtual power plant (VPP). FIG. 2 is a flowchart showing an example of a charging start time setting routine executed by the electronic control unit 40 of the electrified vehicle 20. This routine is executed when a predetermined condition is met. Note that it may be executed only once when a predetermined condition is satisfied, or it may be executed periodically before starting external charging.

When the charging start time setting routine of FIG. 2 is executed, the electronic control unit 40 first inputs the next scheduled driving start time Tdrst, the allowable power Plim of the predetermined facility 70, and the predicted power consumption Pcs of the predetermined facility 70 (S100). Here, as the next scheduled driving start time Tdrst, as described above, the time set by the user may be used, or the time set based on the history of past driving start times may be used. For the allowable power Plim of the predetermined facility 70, contract power (breaker power) is used, for example. The predicted power consumption Pes of the predetermined facility 70 is based on the average power consumption in a predetermined time period during a past predetermined period T1 (for example, about one week to one month) or the next start of driving on weekdays or holidays during the past predetermined period T1. One of the average power consumptions in a predetermined time period to which the scheduled time Tdrst belongs is used. The average power consumption during a predetermined time period on the same day of the week as the next scheduled driving start time Tdrst during a predetermined period T2 in the past (for example, from January to several months) may be used. The predetermined time period may be the entire time period (24 hours), or may be a time period from a predetermined time T3 (for example, about several hours) before the scheduled driving start time Tdrst to the scheduled driving start time Tdrst.

After inputting the data in this way, the predicted power consumption Pcs is subtracted from the allowable power Plim of the predetermined facility 70 to calculate the surplus power Pm (S110), and the scheduled charging power Pch for external charging is set based on the calculated surplus power Pm (S120). In the process of S120, for example, the surplus power Pm or the power (Pm-α) obtained by subtracting the margin α from the surplus power Pm is set as the scheduled charging power Pch.

Then, the charging start time Tchst for external charging is set based on the next scheduled running start time Tdrst and the scheduled charging power Pch for external charging (S130), and this routine ends. In the process of S130, for example, the charging start time Tchst is set to a time that is a margin time ΔT (for example, about several tens of minutes to an hour) before the next scheduled driving start time Tdrst and a charging scheduled time ΔTch earlier than the next scheduled driving start time Tdrst. The scheduled charging time ΔTch can be calculated, for example, by dividing the target charging power amount Qch obtained by converting the difference between the target ratio SOCtg of the battery 26 and the current power storage ratio SOC into a power amount by the scheduled charging power Pch for external charging.

When charging start time Tchst is set in this manner, charging control for controlling bidirectional charging device 32 to perform external charging is started when charging start time Tchst is reached. Thereafter, the charging control is terminated when the power storage ratio SOC of the battery 26 reaches the target ratio SOCtg. Thereby, charging of the battery 26 can be completed by the next scheduled driving start time Tdrst, specifically, around a time that is just the margin time ΔT before the next scheduled driving start time Tdrst. In this embodiment, the charging start time Tchst is set based on the scheduled charging time ΔTch based on the scheduled charging power Pch in external charging. As a result, the larger the scheduled charging power Pch is, the shorter the scheduled charging time ΔTch becomes, and the later the charging start time Tchst becomes. Thereby, it is possible to suppress a shortening of the period during which external power supply is possible, for example, the period during which the electrified vehicle 20 can participate in VPP. In particular, when the scheduled charging power Pch is relatively large, the charging start time Tchst becomes relatively late, so that a more significant effect is produced. Note that when external power supply from the electrified vehicle 20 is possible, the power storage ratio SOC of the battery 26 changes and the target charging power amount Qch changes, so this routine is periodically executed before starting external charging. is preferable.

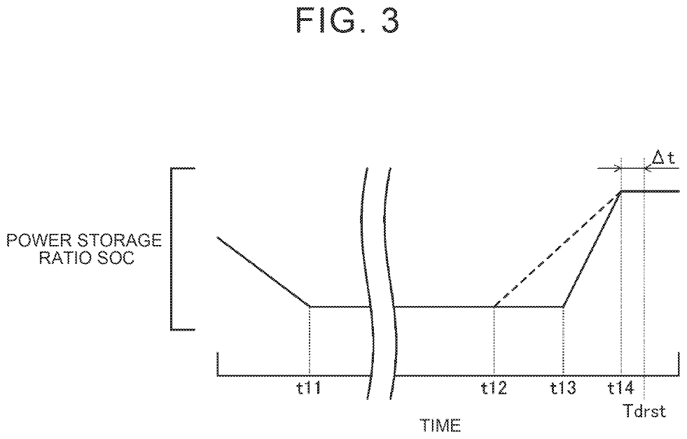

FIG. 3 is an explanatory diagram showing an example of the state of the power storage ratio SOC of the battery 26 of the electrified vehicle 20. In the figure, the solid line shows the state of this embodiment, and the broken line shows the state of the comparative embodiment. In the comparative example, the charging start time Tchst is set by setting the scheduled charging power Pch in external charging to a relatively small power Pch1. In the present embodiment, a case is illustrated in which the scheduled charging power Pch based on the surplus power Pm is sufficiently larger than the power Pch1. In the comparative embodiment, as shown by the broken line in FIG. 3, after a predetermined condition is satisfied at time t1, when charging start time Tchst reaches time t2, external charging is started. When the power storage ratio SOC of the battery 26 reaches the target ratio SOCtg at time t14 (around the time before the scheduled travel start time Tdrst by a margin time ΔT), external charging is terminated. On the other hand, in the present embodiment, as shown by the solid line in FIG. 3, after the predetermined condition is satisfied at time t1, when the charging start time Tchst is reached at time t13, which is after time t12, outer charging starts. When the power storage ratio SOC of the battery 26 reaches the target ration SOCtg at time t14, external charging is terminated. Thereby, it is possible to suppress a shortening of the period during which external power supply is possible, for example, the period during which the electrified vehicle 20 can participate in VPP.

In the electronic control unit 40 as the vehicle management device of the present embodiment described above, when the electrified vehicle 20 can exchange power with the predetermined facility 70, the scheduled charging power Pch for external charging is determined within the range of the allowable power Plim of the predetermined facility 70, and the charging start time Tchst of external charging is set so that the larger the set scheduled charging power Pch is, the later the charging start time Tchst becomes. Thereby, it is possible to suppress shortening of the period during which external power supply is possible. In particular, the effect is more pronounced when the scheduled charging power Pch is relatively large.

In the embodiment described above, the predicted power consumption Pcs is subtracted from the allowable power Plim of the predetermined facility 70 to calculate the surplus power Pm, and the scheduled charging power Pch in external charging is set based on the calculated surplus power Pm. However, the present disclosure is not limited to this, and any method may be used as long as the scheduled charging power Pch is set within the range of the allowable power Plim of the predetermined facility 70. For example, within the range of allowable power Plim of the predetermined facility 70, the scheduled charging power Pch may be set such that the larger the predicted power consumption Pcs is, the smaller the scheduled charging power Pch is.

In the embodiment described above, the charging start time Tchst is set based on the next scheduled driving start time Tdrst. However, instead of this, the charging start time Tchst may be set based on a set time (desired time to end charging of the battery 26) set by the user.

In the embodiment described above, the battery 26 is used as the power storage device. However, instead of this, a capacitor or the like may be used.

In the embodiment described above, the electrified vehicle 20 is configured as a battery electric vehicle including a motor 22, an inverter 24, and a battery 26. However, the electrified vehicle 20 may be configured as a hybrid electric vehicle that includes an engine in addition to the motor 22, inverter 24, and battery 26. Alternatively, it may be configured as a fuel cell electric vehicle that includes a fuel cell in addition to the motor 22, inverter 24, and battery 26.

The correspondence between the main elements of the embodiment and the main elements of the disclosure described in the section of means for solving the problems will be explained. In the embodiment, the battery 26 corresponds to a “power storage device,” the electrified vehicle 20 corresponds to an “electrified vehicle,” and the electronic control unit 40 corresponds to a “vehicle management device.”

Note that the correspondence between the main elements of the embodiment and the main elements of the disclosure described in the column of means for solving the problem is that the embodiment implements the disclosure described in the column of means for solving the problem. Since this is an example for specifically explaining a form for solving the problem, it is not intended to limit the elements of the disclosure described in the column of means for solving the problems. In other words, the interpretation of the disclosure described in the column of means for solving the problem should be made based on the description in that column, and the embodiments should be based on the description of the disclosure described in the column of means for solving the problem. This is just one specific example.

Although embodiments for implementing the present disclosure have been described above, the present disclosure is not limited to these embodiments in any way, and may be implemented in various forms without departing from the gist of the present disclosure. Of course.

The present disclosure can be used in the vehicle management device manufacturing industry and the like.

What is claimed is:

1. A vehicle management device that is used in an electrified vehicle equipped with a power storage device, and sets, when the electrified vehicle is able to transmit and receive power to and from a predetermined facility, a charging start time for external charging for charging the power storage device using power from the predetermined facility, based on a next scheduled travel start time or a set time, wherein when the electrified vehicle is able to transmit and receive the power to and from the predetermined facility, the charging start time is set based on scheduled charging power in the external charging, the scheduled charging power being determined within a range of allowable power of the predetermined facility.

2. The vehicle management device according to claim 1, wherein the charging start time is set to be late as the scheduled charging power is large.

3. The vehicle management device according to claim 1, wherein the scheduled charging power is set based on surplus power obtained as a difference between the allowable power and predicted power consumption of the predetermined facility.

4. The vehicle management device according to claim 3, wherein the predicted power consumption is estimated based on a history for a predetermined period.
